(19) United States
(12) Patent Application Publication
(10) Pub. No.: US 2017/0347374 A1
(43) Pub. Date: Nov. 30, 2017

(54) APPARATUSES AND METHODS FOR CONCURRENT OPERATIONS ON MULTIPLE CHANNELS

(71) Applicant: MediaTek Singapore Pte. Ltd., Singapore (SG)

(72) Inventors: Rahul MAHAJAN, New Delhi (IN); Prakhar VIG, UTTAR PRADESH (IN); Abhijit UPLENCHWAR, Uttar Pradesh (IN)

(21) Appl. No.: 15/260,661

(22) Filed: Sep. 9, 2016

(30) Foreign Application Priority Data
May 28, 2016 (IN) 201621018417

(51) Int. Cl. H04W 74/08; H04W 76/02; H04W 72/04

(52) U.S. Cl. CPC H04W 74/0816; H04W 72/0446; H04W 76/023

(57) ABSTRACT

A wireless communication device including first and second circuitry is provided. The first circuitry is configured to wirelessly communicate with an access point when the wireless communication device operates in a first mode on a first channel. The second circuitry is configured to send a CLEAR TO SEND (CTS)-TO-SELF (CTS-2-SELF) packet to the access point in response to the wireless communication device going to switch from operating in the first mode on the first channel to operate in a second mode on a second channel for a period of time.

### CROSS REFERENCE TO RELATED APPLICATIONS

This Application claims priority of India Application No. 201621018417, filed on May 28, 2016, the entirety of which is incorporated by reference herein.

### BACKGROUND OF THE APPLICATION

### Field of the Application

The application relates generally to the coordination of operations on multiple channels, and more particularly, to apparatuses and methods for concurrent operations on multiple channels.

### Description of the Related Art

The development of various wireless technologies has led to situations where it is desirable to have a single device supporting multiple network contexts. The Wireless Fidelity (WiFi) technology is conventionally employed for a network configuration which is typically based on the presence of a controller device known as wireless Access Points (AP). The AP acts as a central hub to which WiFi capable devices (also referred to as Stations (STAs)) are connected. The STAs do not communicate directly with each other, but they go through the AP.

However, in another network configuration according to the WiFi Direct standard, two terminal devices may communicate directly with each other without the need for a central AP. There are two types of roles defined in a WiFi Direct network: Group Owner (GO) and Group Client (GC), wherein, the GO can be used as an STA or AP, and can also establish Point-to-Point (P2P) secure connections with multiple GCs; while the GC is similar to STA, and can establish a P2P secure connection with the GO. By following the WiFi Direct standard, a terminal device can be chosen as the GO, and is simultaneously connected to the GCs, such as a notebook, a smart TV, and other devices, so as to facilitate direct communications with the GCs.

### BRIEF SUMMARY OF THE APPLICATION

In one aspect of the application, a wireless communication device comprising first and second circuitry is provided. The first circuitry is configured to wirelessly communicate with an access point when the wireless communication device operates in a first mode on a first channel. The second circuitry is configured to send a CLEAR TO SEND (CTS)-TO-SELF (CTS-2-SELF) packet to the access point in response to the wireless communication device going to switch from operating in the first mode on the first channel to operate in a second mode on a second channel for a period of time.

In another aspect of the application, a method for concurrent operations on multiple channels is provided. The method is executed by a wireless communication device selectively operating in a first mode on a first channel or in a second mode on a second channel for wireless communication. The method comprises the steps of: wirelessly communicating with an access point when the wireless communication device operates in the first mode on the first channel; and sending a CTS-2-SELF packet to the access point in response to the wireless communication device going to switch from operating in the first mode on the first channel to operate in the second mode on the second channel for a period of time.

Other aspects and features of the application will become apparent to those with ordinary skill in the art upon review of the following descriptions of specific embodiments of the wireless communication devices and methods for concurrent operations on multiple channels.

### BRIEF DESCRIPTION OF THE DRAWINGS

The application can be more fully understood by reading the subsequent detailed description and examples with references made to the accompanying drawings, wherein:

FIG. 1 is a block diagram of a wireless communication environment according to an embodiment of the application;

FIG. 2 is a block diagram illustrating the wireless communication device 121 according to an embodiment of the application;

FIG. 3 is a flow chart illustrating the method for concurrent operations on multiple channels in a wireless communication device according to an embodiment of the application;

FIG. 4 is a schematic diagram illustrating concurrent operations on multiple channels according to an embodiment of the application; and

FIG. 5 is a schematic diagram illustrating concurrent operations on multiple channels according to another embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The IEEE standard is used to teach the spirit of the application, and the application is not limited thereto.

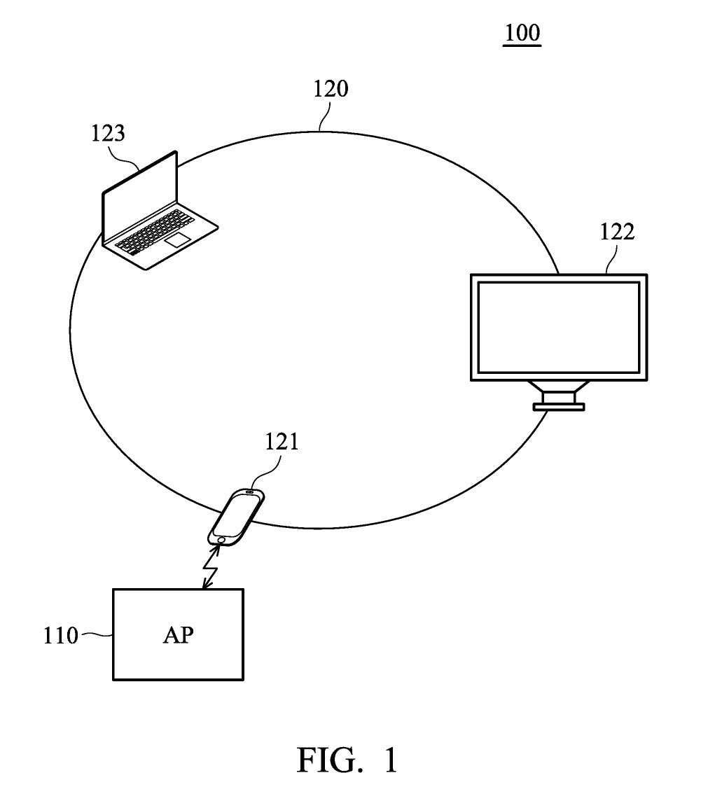

FIG. 1 is a block diagram of a wireless communication environment according to an embodiment of the application. The wireless communication environment 100 includes one AP 110 and three wireless communication devices 121˜123, wherein the wireless communication devices 121˜123 are all WiFi-Direct capable devices and they further form a WiFi Direct network 120. Each of the wireless communication devices 121˜123 may be a mobile phone, panel Personal Computer (PC), notebook, smart TV, gaming console, or any computing device which supports WiFi Direct communications.

The wireless communication device 121 is the GO in the WiFi Direct network 120, and may be configured to selectively operate in the STA mode or WFD-GO mode, wherein the STA mode and WFD-GO mode are operated on different channels. In one embodiment, the STA mode may be operated on channel 1 (2412 MHz), while the WFD-GO mode may be operated on channel 11 (2462 MHz). When operating in the STA mode, the wireless communication device 121 may wirelessly connect to the AP 110 which acts as a central hub for Bridging and routing traffic for the wireless communication device 121. When operating in the WFD-GO mode, the wireless communication device 121 may function as a soft AP to which the GCs (i.e., the wireless communication devices 122 and 123) connect for sharing files with each other in the WiFi Direct network 120.

In the WiFi Direct network 120, the wireless communication devices 121˜123 have to go through several steps, including find, GO negotiation, provisioning, and connect steps, to establish P2P connections with each other.

In the find step, a wireless communication device searches and discovers other wireless communication devices and their configurations. In the WiFi Direct standard, certain conventional WiFi channels are designated as social channels. Each wireless communication device selects one of these social channels as its listen channel. Finding other wireless communication devices typically involves a given wireless communication device alternating between transmitting probe requests on its social channels and listening for corresponding probe responses from the other wireless communication devices on its listen channel. In that regard, it may take some time before a probe request transmitted on the correct social channel is acknowledged by a peer device listening on the same channel as its listen channel. When this happens, the peer device and its listen channel are found.

Once a wireless communication device has found another peer device that is not already a GO, a GO negotiation ensues between the wireless communication devices. Analogous to the AP 110, a GO manages and authenticates other peers in the P2P group. In standard group formation, the GO negotiation step involves a handshaking between the wireless communication devices in which they independently generate a GO Intent parameter. The device declaring the highest value for this parameter becomes the GO. After the wireless communication device 121 becomes a GO, it operates on an operating channel that may or may not be the same as one of the social channels.

Once a GO has been declared and the wireless communication devices agree on their respective roles, the wireless communication devices go through the provisioning step to establish a secure connection using WiFi Simple Configuration (WSC) protocols. The GO serves the role as a soft AP with an internal registrar to enroll the other device as the P2P client. In this regard, the GO issues network credentials, i.e., security keys, to the P2P client and authenticates the P2P client. Upon successful completion of the provisioning step, the wireless communication devices go through the final connect step to complete the P2P connection. During the connect step, the GO runs a Dynamic Host Configuration Step (DHCP) to provide the P2P client with Internet Protocol (IP) addresses.

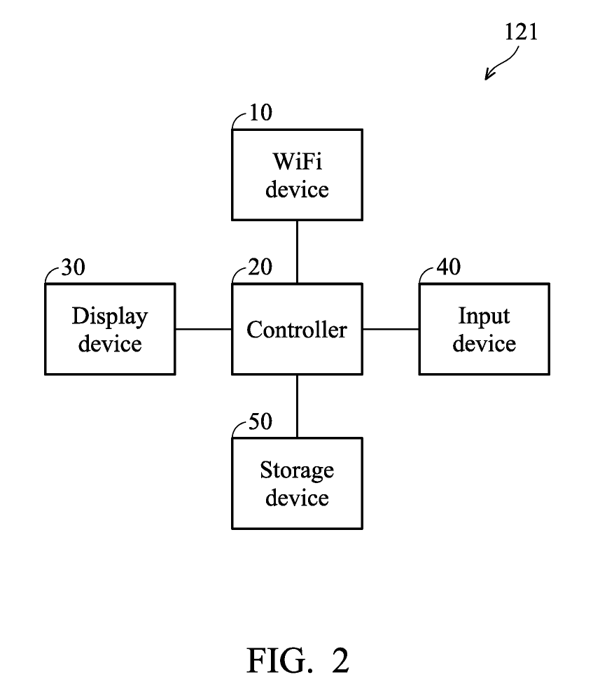

FIG. 2 is a block diagram illustrating the wireless communication device 121 according to an embodiment of the application. The wireless communication device 121 includes a WiFi device 10, a controller 20, a display device 30, an input device 40, and a storage device 50.

The WiFi device 10 may contain a Radio Frequency (RF) device, a baseband processing device, and an antenna. The baseband processing device may contain multiple hardware components to perform baseband signal processing, including Analog-to-Digital Conversion (ADC)/Digital-to-Analog Conversion (DAC), gain adjusting, modulation/demodulation, encoding/decoding, and so on. The RF device may receive RF wireless signals via the antenna, convert the received RF wireless signals to baseband signals, which are processed by the baseband processing device, or receive baseband signals from the baseband processing device and convert the received baseband signals to RF wireless signals, which are later transmitted via the antenna. The RF device may also contain multiple hardware components to perform radio frequency conversion. For example, the RF device may comprise a mixer to multiply the baseband signals with a carrier oscillated in the radio frequency of the supported cellular technologies, wherein the radio frequency may be 2.4 GHz, 3.6 GHz, 4.9 GHz, or 5 GHz utilized in the WiFi technology, or another radio frequency, depending on the standard version of the WiFi technology in use.

The controller 20 may be a general-purpose processor, Micro-Control Unit (MCU), Digital Signal Processor (DSP), application processor, or the like, which includes various circuitry for providing the function of data processing and computing, controlling the WiFi device 10 for WiFi communications, sending a series of frame data (e.g. representing text messages, graphics, images, etc.) to the display device 30, receiving signals from the input device 40, and storing and retrieving data to and from the storage device 50. In particular, the controller 20 coordinates the aforementioned operations of the WiFi device 10, the display device 30, the input device 40, and the storage device 50 for performing the method of the present application.

As will be appreciated by persons skilled in the art, the circuitry will typically comprise transistors that are configured in such a way as to control the operation of the circuitry in accordance with the functions and operations described herein. As will be further appreciated, the specific structure or interconnections of the transistors will typically be determined by a compiler, such as a register transfer language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

In another embodiment, the controller 20 may be incorporated into the WiFi device 10, serving as a baseband processor.

The display device 30 may be a Liquid-Crystal Display (LCD), Light-Emitting Diode (LED) display, or Electronic Paper Display (EPD), etc., for providing a display function. Alternatively, the display device 30 may further include one or more touch sensors disposed thereon or thereunder for sensing touches, contacts, or approximations of objects, such as fingers or styluses.

The input device 40 may include one or more buttons, a keyboard, a mouse, a touch pad, a video camera, a microphone, and/or a speaker, etc., serving as the Man-Machine Interface (MIMI) for interaction with users.

The storage device 50 is a non-transitory machine-readable storage medium, including a memory, such as a FLASH memory or a Non-volatile Random Access Memory (NVRAM), or a magnetic storage device, such as a hard disk or a magnetic tape, or an optical disc, or any combination thereof for storing instructions or program code of communication protocol or applications.

It should be understood that the components described in the embodiment of FIG. 2 are for illustrative purposes only and are not intended to limit the scope of the application. For example, the wireless communication device 121 may include more components to support other wireless technologies, such as the Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA2000) technology, Time Division-Synchronous Code Division Multiple Access (TD-SCDMA) technology, Worldwide Interoperability for Microwave Access (WiMAX) technology, Long Term Evolution (LTE) technology, Time-Division LTE (TD-LTE) technology, and LTE-Advanced (LTE-A) technology, etc.

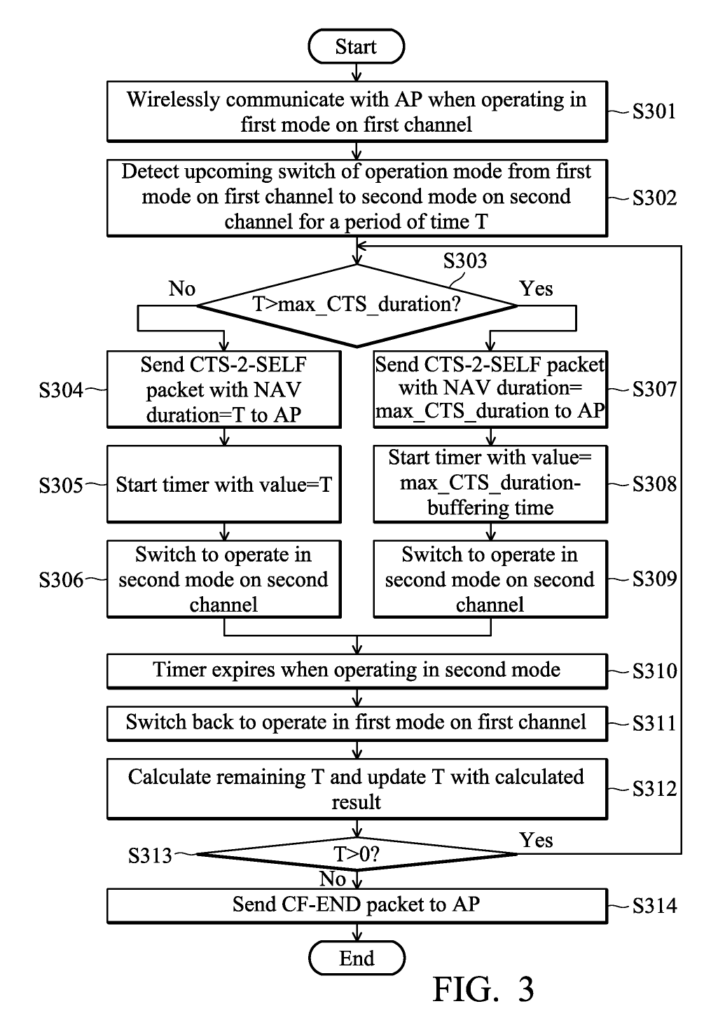

FIG. 3 is a flow chart illustrating the method for concurrent operations on multiple channels in a wireless communication device according to an embodiment of the application. To begin, the wireless communication device wirelessly communicates with an AP when operating in the first mode on the first channel (step S301). In one embodiment, the first mode is the STA mode and the first channel is WiFi channel 1. Next, it is detected that the operation mode of the wireless communication device is going to switch from the first mode on the first channel to the second mode on the second channel for a period of time (denoted as T in FIG. 3) (step S302). In one embodiment, the switching of operation mode may be detected by determining whether the time slice scheduled for the operation in the first mode (also referred to as STA time slice) is going to expire. In one embodiment, the second mode is the WFD-GO mode and the second channel is WiFi channel 11. The period of time may be the time slice scheduled for operations in the WFD-GO mode, and is referred to herein as the WFD-GO time slice.

In response to the detection of operation mode switching, the wireless communication device determines whether the WFD-GO time slice is greater than the maximum CTS duration (denoted as max_CTS_duration in FIG. 3) (step S303), and if not, the wireless communication device sends a CLEAR TO SEND (CTS)-TO-SELF (CTS-2-SELF) packet, which includes a Network Allocation Vector (NAV) duration set to a value of the WFD-GO time slice, to the AP (step S304), and starts a timer to count the WFD-GO time slice (step S305). In one embodiment, the maximum CTS duration is 32 milliseconds. Specifically, the CTS-2-SELF packet is used to indicate to other WiFi stations and the AP to clear the first channel. That is, when receiving the CTS-2-SELF packet, the AP stops transmitting downlink data to the wireless communication device. Subsequent to step S305, the wireless communication device switches to operate in the second mode on the second channel (step S306).

Subsequent to step S303, if the WFD-GO time slice is greater than the maximum CTS duration, the wireless communication device sends a CTS-2-SELF packet, which includes a NAV duration set to a value of the maximum CTS duration, to the AP (step S307), and starts a timer to count the maximum CTS duration minus a buffering time (step S308). Next, the wireless communication device switches to operate in the second mode on the second channel (step S309). Specifically, the buffering time is configurable to enable the timer to expire a while prior to the maximum CTS duration having elapsed, so that the wireless communication device may be able to send out another CTS-2-SELF packet successfully. For example, the buffering time may be 4 milliseconds.

Subsequent to steps S306 and S309, the timer expires when the wireless communication device operates in the second mode (step S310). In response to the timer having expired, the wireless communication device switches back to operate in the first mode on the first channel (step S311) and calculates the remaining WFD-GO time slice and updates the WFD-GO time slice with the calculated result (step S312). Specifically, if the original WFD-GO time slice is less than or equal to the maximum CTS duration, the remaining WFD-GO time slice is equal to 0. Otherwise, if the original WFD-GO time slice is greater than the maximum CTS duration, the remaining WFD-GO time slice is equal to the WFD-GO time slice minus the maximum CTS duration.

Subsequent to step S312, the wireless communication device determines whether the remaining WFD-GO time slice is greater than 0 (step S313), and if so, the method flow goes to step S303. Otherwise, if the WFD-GO time slice is not greater than 0, the wireless communication device sends a Contention Free-END (CF-END) packet to the AP for channel reservation cancellation (step S314), and the method ends. Specifically, the CF-END packet is used to indicate to other WiFi stations and the AP that they are allowed to enable WiFi communications.

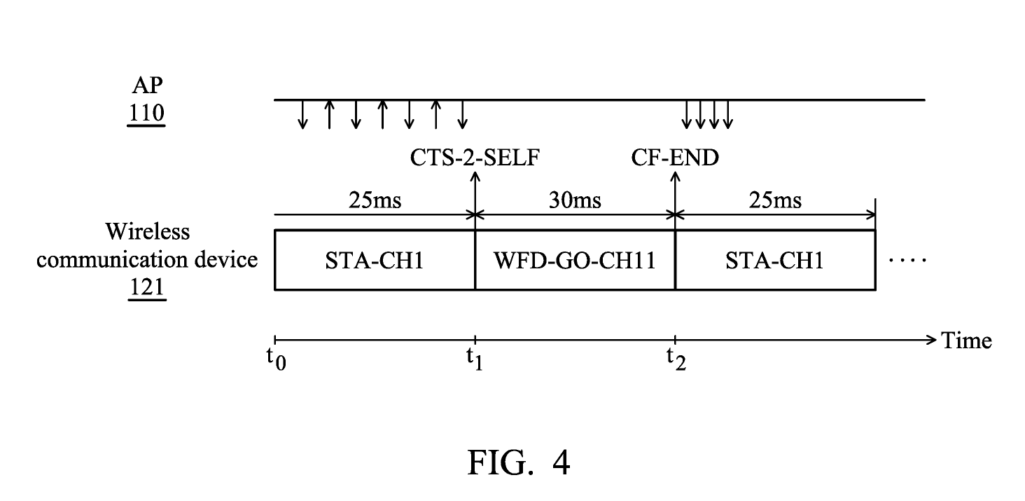

FIG. 4 is a schematic diagram illustrating concurrent operations on multiple channels according to an embodiment of the application. In this embodiment, the concurrent operations include operations in the STA mode on WiFi channel 1 and operations in the WFD-GO mode on WiFi channel 11, wherein the time slice scheduled for the STA mode is 25 milliseconds and the time slice scheduled for the WFD-GO mode is 30 milliseconds.

At time t₀, the wireless communication device 121 operates in the STA mode on WiFi channel 1 for transmitting uplink data or receiving downlink data to or from the AP 110. At time t₁ (i.e., the end of the STA time slice), the wireless communication device 121 sends a CTS-2-SELF packet to the AP 110, and then switches to operate in the WFD-GO mode on WiFi channel 11. Since the WFD-GO time slice is less than the maximum CTS duration (i.e., 32 milliseconds), the NAV duration in the CTS-2-SELF packet is set to the complete WFD-GO time slice (i.e., 30 milliseconds). Meanwhile, the AP 110 stops transmitting downlink data to the wireless communication device 121 when receiving the CTS-2-SELF packet.

At time t₂ (i.e., the end of the WFD-GO time slice), the wireless communication device 121 switches to operate in the STA mode on WiFi channel 1 and sends a CF-END packet to the AP 110. When receiving the CF-END packet, the AP 110 may start transmitting downlink data to the wireless communication device 121.

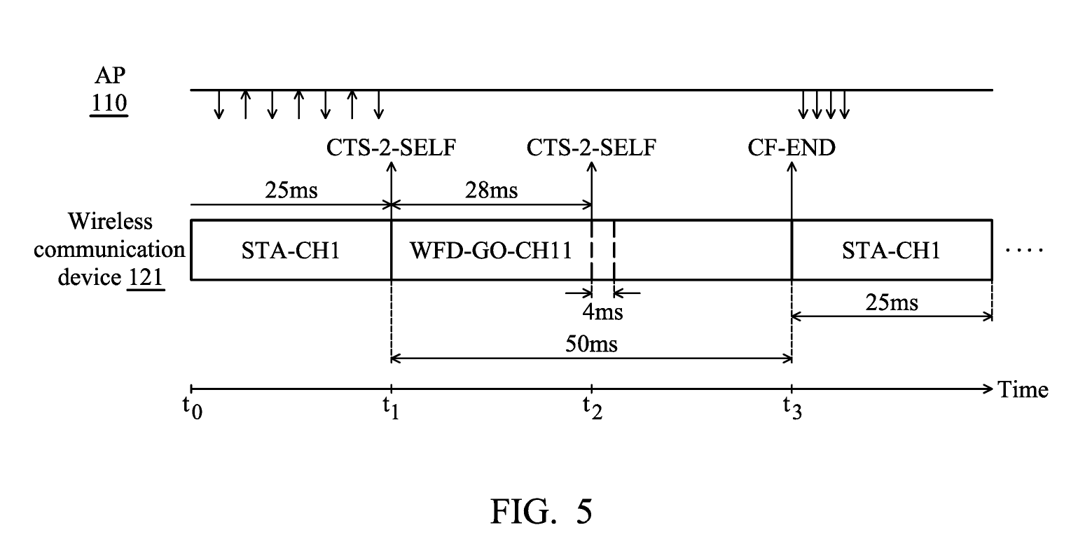

FIG. 5 is a schematic diagram illustrating concurrent operations on multiple channels according to another embodiment of the application. In this embodiment, the time slice scheduled for the STA mode is 25 milliseconds and the time slice scheduled for the WFD-GO mode is 50 milliseconds.

At time t₀, the wireless communication device 121 operates in the STA mode on WiFi channel 1 for transmitting uplink data or receiving downlink data to or from the AP 110. At time t₁ (i.e., the end of the STA time slice), the wireless communication device 121 sends a CTS-2-SELF packet to the AP 110, and then switches to operate in the WFD-GO mode on WiFi channel 11. Since the WFD-GO time slice is greater than the maximum CTS duration (i.e., 32 milliseconds), the NAV duration in the CTS-2-SELF packet is set to the maximum CTS duration. Meanwhile, the AP 110 stops transmitting downlink data to the wireless communication device 121 when receiving the CTS-2-SELF packet.

At time t₂ which is a buffering time prior to the maximum CTS duration having elapsed (i.e., t₁+(32-4) milliseconds), the wireless communication device 121 temporarily switches to operate in the STA mode on WiFi channel 1 to send another CTS-2-SELF packet to the AP 110. Once the CTS-2-SELF packet is sent successfully, the wireless communication device 121 switches back to operate in the WFD-GO mode. Specifically, the CTS-2-SELF packet includes a NAV duration set to the WFD-GO time slice minus the maximum CTS duration (i.e., 50−32=18 milliseconds).

At time t₃ (i.e., the end of the WFD-GO time slice), the wireless communication device 121 switches to operate in the STA mode on WiFi channel 1 and sends a CF-END packet to the AP 110. When receiving the CF-END packet, the AP 110 may start transmitting downlink data to the wireless communication device 121.

Please note that, the Electrical and Electronics Engineers (IEEE) 802.11 standard does not define any specific procedure for concurrent operations on multiple channels. Although the wireless communication device may send a null frame with a set Power Saving (PS) bit to stop the AP from downlink data transmission and the AP may buffer the downlink data until another null frame with PS bit reset has been received, there are situations where the AP may ignore the null frame and continue the downlink data transmission. As a result, the wireless communication device may have switched to the WFD-GO mode after sending the null frame and will not be able to receive the downlink data from the AP, causing excessive retries of downlink data transmission in the AP. In addition, the transceiving rate may drop (i.e., throughput degradation) or even connection loss for the STA mode communications may occur between the AP and the wireless communication device.

In view of the forgoing embodiments of FIGS. 3-5, it will be appreciated that the present application realizes improvements on concurrent multi-channel operations by using the CTS-2-SELF packet, instead of the null frame with the PS bit set, to successfully refrain the other WiFi capable devices, including the AP, from data transceiving on the WiFi channel for the STA mode. Advantageously, throughput degradation or undesired connection loss for the STA mode communications between the AP and the wireless communication device can be avoided.

While the application has been described by way of example and in terms of preferred embodiment, it is to be understood that the application is not limited thereto. Those who are skilled in this technology can still make various alterations and modifications without departing from the scope and spirit of this application. Therefore, the scope of the present application shall be defined and protected by the following claims and their equivalents.

What is claimed is:

1. A wireless communication device, comprising:
first circuitry configured to wirelessly communicate with an access point when the wireless communication device operates in a first mode on a first channel; and
second circuitry configured to send a CLEAR TO SEND (CTS)-TO-SELF (CTS-2-SELF) packet to the access point in response to the wireless communication device going to switch from operating in the first mode on the first channel to operate in a second mode on a second channel for a period of time.

2. The wireless communication device as claimed in claim 1, further comprising:
third circuitry configured to determine whether the period of time is greater than a maximum CTS duration,
wherein the CTS-2-SELF packet comprises a Network Allocation Vector (NAV) duration set to a value of the period of time when the period of time is not greater than the maximum CTS duration.

3. The wireless communication device as claimed in claim 2, further comprising:
fourth circuitry configured to, in response to the period of time having elapsed since the CTS-2-SELF packet was sent, switch the wireless communication device from operating in the second mode on the second channel to operate in the first mode on the first channel, to send a Contention Free-END (CF-END) packet to the access point.

4. The wireless communication device as claimed in claim 2, wherein the CTS-2-SELF packet comprises a NAV duration set to the value of the maximum CTS duration when the period of time is greater than the maximum CTS duration.

5. The wireless communication device as claimed in claim 4, further comprising:
fifth circuitry configured to switch, in a buffering time prior to the maximum CTS duration having elapsed, the wireless communication device from operating in the second mode on the second channel to operate in the first mode on the first channel, to send another CTS-2-SELF packet to the access point; and
sixth circuitry configured to switch the wireless communication device back to operate in the second mode on the second channel when the other CTS-2-SELF packet has been sent to the access point successfully.

6. The wireless communication device as claimed in claim 5, wherein the buffering time is configurable to enable the other CTS-2-SELF packet to be sent to the access point successfully.

7. The wireless communication device as claimed in claim 5, wherein the other CTS-2-SELF packet comprises a NAV duration set to the value of the period of time minus the maximum CTS duration.

8. The wireless communication device as claimed in claim 7, further comprising:
seventh circuitry configured to, in response to the NAV duration of the other CTS-2-SELF packet having elapsed since the other CTS-2-SELF packet was sent, switch the wireless communication device from operating in the second mode on the second channel to operate in the first mode on the first channel, to send a CF-END packet to the access point.

9. The wireless communication device as claimed in claim 1, wherein the first and second modes are a Station (STA) mode and a WiFi Direct-Group Owner (WFD-GO) mode, respectively.

10. A method for concurrent operations on multiple channels, which is executed by a wireless communication device selectively operating in a first mode on a first channel or in a second mode on a second channel for wireless communication, the method comprising:
wirelessly communicating with an access point when the wireless communication device operates in the first mode on the first channel; and
sending a CLEAR TO SEND (CTS)-TO-SELF (CTS-2-SELF) packet to the access point in response to the wireless communication device going to switch from operating in the first mode on the first channel to operate in the second mode on the second channel for a period of time.

11. The method as claimed in claim 10, further comprising:
determining whether the period of time is greater than a maximum CTS duration,
wherein the CTS-2-SELF packet comprises a Network Allocation Vector (NAV) duration set to a value of the period of time when the period of time is not greater than the maximum CTS duration.

12. The method as claimed in claim 11, further comprising:
in response to the period of time having elapsed since the CTS-2-SELF packet was sent, switching the wireless communication device from operating in the second mode on the second channel to operate in the first mode on the first channel, to send a Contention Free-END (CF-END) packet to the access point.

13. The method as claimed in claim 11, wherein the CTS-2-SELF packet comprises a NAV duration set to the value of the maximum CTS duration when the period of time is greater than the maximum CTS duration.

14. The method as claimed in claim 13, further comprising:
switching, in a buffering time prior to the maximum CTS duration having elapsed, the wireless communication device from operating in the second mode on the second channel to operate in the first mode on the first channel, to send another CTS-2-SELF packet to the access point; and
switching the wireless communication device back to operate in the second mode on the second channel when the other CTS-2-SELF packet has been sent to the access point successfully.

15. The method as claimed in claim 14, wherein the buffering time is configurable to enable the other CTS-2-SELF packet to be sent to the access point successfully.

16. The method as claimed in claim 14, wherein the other CTS-2-SELF packet comprises a NAV duration set to the value of the period of time minus the maximum CTS duration.

17. The method as claimed in claim 16, further comprising:
in response to the NAV duration of the other CTS-2-SELF packet having elapsed since the other CTS-2-SELF packet was sent, switching the wireless communication device from operating in the second mode on the second channel to operate in the first mode on the first channel, to send a CF-END packet to the access point.

18. The method as claimed in claim 10, wherein the first and second modes are a Station (STA) mode and a WiFi Direct-Group Owner (WFD-GO) mode, respectively.
